(19) United States
(12) Patent Application Publication
(10) Pub. No.: US 2009/0050703 A1
(43) Pub. Date: Feb. 26, 2009

(54) HVAC&R System Control Utilizing On-Line Weather Forecasts

(75) Inventors: Alexander Lifson, Manlius, NY (US); Michael F. Taras, Fayetteville, NY (US)

Correspondence Address: CARLSON, GASKEY & OLDS, P.C., 400 WEST MAPLE ROAD, SUITE 350, BIRMINGHAM, MI, 48009, US

(73) Assignee: CARRIER CORPORATION, Syracuse, NY (US)

(21) Appl. No.: 12/295,649

(22) PCT Filed: Apr. 12, 2006
(86) PCT No.: PCT/US2006/013725

§ 371 Date: Oct. 1, 2008

(51) Int. Cl. G05D 23/00

(52) U.S. Cl. 236/51

(57) ABSTRACT

A controller for an HVAC & R system is provided with the Internet connection to weather forecast information. The weather forecast information is utilized by the controller to take proactive steps in system operation and control. As an example, should the weather forecast information indicate that temperatures will be rising dramatically the next day, the controller may take the proactive step of increasing cooling in the conditioned space during the nighttime. In this manner, when the ambient temperature begins to rise the next day, the cooling load on the HVAC & R system components will be lower. Analogous proactive steps can be taken regarding humidity and fresh air circulation rate within the conditioned space. The present invention not only provides more prompt tailoring of the conditions within an environment to desired conditions, but also does so in a more efficient and less expensive manner

### BACKGROUND OF THE INVENTION

This application relates to a heating, ventilation, air conditioning and refrigeration (HVAC&R) system control, which receives weather forecast information over an information carrying media, such as the Internet, and utilizes that upcoming predicted weather information to take proactive steps with regard to current HVAC&R system control.

HVAC&R systems are utilized to provide a conditioned airstream with respect to temperature and humidity to control a conditioned environment such as, for example, supermarket display cases, homes or other building spaces, container refrigeration units or truck & trailer units. Typically, a control takes in information with regard to desired conditions in the space to be cooled or heated, and determines the optimal control logic for the HVAC&R system components to achieve those desired conditions. Thus, as an example, a user or resident of the building may choose a desired temperature to be maintained in the conditioned space. As ambient or outdoor conditions change, the HVAC&R system control will continue to modify system operation to achieve that desired temperature. Typically, a desired temperature, humidity and fresh air circulation rate are controlled to achieve the desired condition in the immediate future. That is, the controls do not anticipate anything about what might occur with ambient conditions during an extended period of time.

Weather forecast information has become more and more accurate. Moreover, weather forecast information is easily available over the Internet. However, this information has never been tied to an HVAC&R system control.

### SUMMARY OF THE INVENTION

In a disclosed embodiment of this invention, a controller for an HVAC&R system receives weather forecast information over an information carrying media, such as the Internet. This weather forecast information is utilized to allow the HVAC&R system control to determine and take proactive steps. As one example, should the weather forecast indicate that there will be a sharp rise in temperature the next day, the controller may begin to provide higher cooling levels during the course of the night. In this manner, the gradual increase in cooling load can be achieved before the HVAC&R system needs to overcome the high rise in the outside ambient temperature. An added benefit of this approach might well be that electricity costs are lower during the off-peak hours. For these reasons, the HVAC&R system operation might be more efficient and less expensive while operating in this proactive manner. On the other hand, if the ambient temperature is expected to decrease, it could be more efficient for the HVAC&R system control to take proactive steps in preemptive switching to part-load operation.

A worker of ordinary skill in the art would easily visualize how a furnace (or heat pump) can be proactively utilized to provide increased heat when a significant ambient temperature decline is expected.

Analogously, the proactive control logic utilizing weather forecast can be employed with respect to controlling humidity or fresh air circulation rate in the conditioned space.

While the present invention would be utilized in HVAC&R systems associated with any building or conditioned space, it may well be best suited for use in large office buildings with large thermal mass or a large refrigeration container unit carrying a frozen cargo. Also, since the buildings are typically vacant in the evening hours, the fact that the temperature and humidity are moved away from desired setpoints, as a “proactive” step, is unlikely to cause significant discomfort to any large number of occupants.

These and other features of the present invention can be best understood from the following specification and drawings, the following of which is a brief description.

### BRIEF DESCRIPTION OF THE DRAWINGS

FIG. 1 is a schematic view of a building incorporating the present invention.

FIG. 2 is a flow chart of the present invention.

### DETAILED DESCRIPTION OF THE PREFERRED EMBODIMENTS

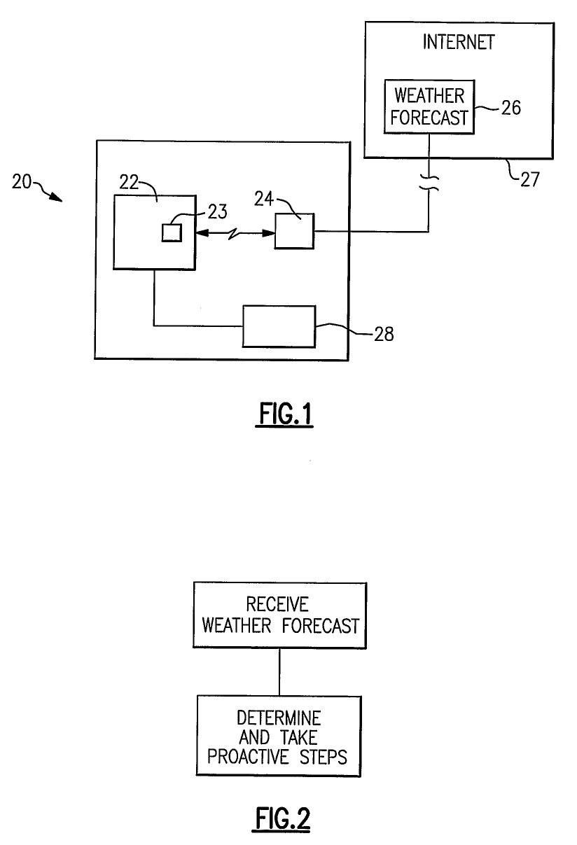

A building 20 is illustrated schematically in FIG. 1. A controller 22 for HVAC&R system components 28 is provided with an interface member 23. The interface member 23 allows a resident or occupant of the building 20 to input desired temperature and/or humidity and/or fresh air circulation rate information to the controller. The HVAC&R system components 28 may include a furnace, an air conditioner, a heat pump, an air handler, a chiller, a cooling tower, etc. As shown in FIG. 1, a connection to a weather forecast source of information 26 over the information carrying media such as Internet 27 is provided to the control 22. As shown schematically in FIG. 1, a local computer, hub or router 24 might provide a wireless connection to the controller 22. Alternatively, if appropriate, a hard-wired connection to the Internet may be provided directly to the controller 22.

Weather forecast information is now available to the controller 22. This weather forecast information can be utilized by the controller 22 to determine and take proactive steps in optimal system operation and control.

As an example, and as shown in the flow chart of FIG. 2, once the weather forecast information is provided to the controller 22, the controller can determine appropriate proactive steps based upon the received and most current weather forecast to achieve optimal system operation and control.

As one example, should the weather forecast indicate that the next day's temperature will rise sharply, the controller 22 might determine it would be optimal to begin taking proactive steps during the nighttime to counteract the increased cooling load during the daytime. Thus, the HVAC&R system components 28 might have the air conditioning components or subsystems actuated in the nighttime such that the actual temperature of the building 20 is maintained below the desired temperature inputted through the interface member 23 for the nighttime hours. The HVACR component, for example, may include compressors for pumping refrigerant through the system or fans for moving air over condenser and evaporator coils. In this manner, the next day when the cooling load requirements increase sharply, a significant portion of this load will already have been covered. If the building 20 is an office building that has significant thermal mass and is typically unoccupied in the nighttime, these proactive steps are more important and will be of little discomfort to the users of the building. Moreover, by taking advantage of the evening hours low electricity demand and prices to counterbalance a portion of the anticipated cooling load during the daytime, electricity will be utilized at a time when it is more readily available, and less expensive than it would be the following day. On the other hand, if the ambient temperature is expected to decrease, it could be more efficient for the HVAC&R system control to take proactive steps in preemptive switching to part-load operation.

The exact opposite steps can be taken should the weather forecast indicate that the temperature is likely to drop significantly. For instance, furnace or heat pump can be similarly controlled and operated to provide proactive heating in anticipation of such temperature decline.

Analogously, the proactive control logic utilizing weather forecast can be employed with respect to controlling humidity or fresh air circulation rate in the conditioned space.

The present invention thus provides better tailoring of system control and operation to maintain desired building conditions, while also being more efficient and less expensive than the prior art. Since the access to the most current weather forecast is always available via the Internet, this data is recorded on a continuous basis to provide the most up-to-date information.

Although a preferred embodiment of this invention has been disclosed, a worker of ordinary skill in this art would recognize that certain modifications would come within the scope of this invention. For that reason, the following claims should be studied to determine the true scope and content of this invention.

1-22. (canceled)

23. An HVAC&R system comprising:
a controller for controlling HVAC&R system components, said components being operable to provide at least temperature control to an environment to be conditioned; and
weather forecast information provided from a remote source to said controller, said weather forecast information being utilized by said controller to determine proactive steps for controlling said HVAC&R system components, said weather forecast information including temperature and humidity forecasts, and said controller also using cost and availability of a supplied energy source, and an internal load schedule for the environment to be conditioned to determine said proactive steps.

24. The HVAC&R system as set forth in claim 23, wherein said HVAC&R system is used to provide at least temperature control for one of a building, supermarket, residential house, automobile, bus, container refrigeration unit, and a truck-trailer unit.

25. The HVAC&R system as set forth in claim 23, wherein said weather forecast information is provided to said controller over the Internet.

26. The HVAC&R system as set forth in claim 25, wherein said weather forecast information is provided to said controller over a wireless connection.

27. The HVAC&R system as set forth in claim 23, wherein said controller utilizes an anticipated change in outdoor temperature, to take proactive steps of addressing this change prior to the change beginning to occur.

28. The HVAC&R system as set forth in claim 27, wherein said controller increases cooling or decreases heating such that it may cool the environment to be conditioned below a desired temperature should the weather forecast information indicate that outdoor temperature will be increasing in the future.

29. The HVAC&R system as set forth in claim 27, wherein said controller increases heating or decreases cooling such that it may heat the environment to be conditioned above a desired temperature should the weather forecast information indicate that outside temperature will be decreasing in the future.

30. The HVAC&R system as set forth in claim 23, wherein said controller utilizes an anticipated change in outdoor humidity, to take proactive steps of addressing this change prior to the change beginning to occur.

31. The HVAC&R system as set forth in claim 23, wherein weather forecast information is stored in a database and is updated on a periodic basis.

32. The HVAC&R system as set forth in claim 23, wherein humidity is also controlled.

33. The HVAC&R system as set forth in claim 23, wherein fresh air circulation rate is also controlled.

34. The HVAC&R system as set forth in claim 23, wherein said energy cost and availability information also being supplied from the remote source.

35. A method of controlling an HVAC&R system comprising:
(1) providing a controller for controlling HVAC&R system components, said components being operable to provide at least temperature control to an environment to be conditioned; and
(2) providing weather forecast information from a remote source to said controller, said weather forecast information being utilized by said controller to determine proactive steps for controlling said HVAC&R system components, said weather forecast information including temperature and humidity forecasts, and said controller also using cost and availability of a supplied energy source, and an internal load schedule for the environment to be conditioned to determine said proactive steps.

36. The method as set forth in claim 35, wherein said HVAC&R system is used to provide at least temperature control for one of a building, supermarket, residential house, automobile, bus, container refrigeration unit, and a truck-trailer unit.

37. The method as set forth in claim 35, wherein said weather forecast information is provided to said controller over the Internet.

38. The method as set forth in claim 37, wherein said weather forecast information is provided to said controller over a wireless connection.

39. The method as set forth in claim 37, wherein said controller utilizes an anticipated change in outside temperature, to take proactive steps of addressing this change prior to the change beginning to occur.

40. The method as set forth in claim 39, wherein said controller increases cooling or decreases heating such that it cools the environment to be conditioned below a desired temperature should the weather forecast information indicate that outside temperature will be increasing in the future.

41. The method as set forth in claim 39, wherein said energy cost and availability information also being supplied from the remote source.

42. The method as set forth in claim 37, wherein said controller utilizes an anticipated change in outside humidity, to take proactive steps of addressing this change prior to the change beginning to occur.
